(19) United States
(12) Patent Application Publication
(10) Pub. No.: US 2013/0276533 A1
(43) Pub. Date: Oct. 24, 2013

(54) DEVICE FOR MEASURING FLUID LEVEL IN A CONTAINER

(71) Applicants: Haim Wilder, Raanana (IL); Yaniv Matza, Kfar Saba (IL)

(72) Inventors: Haim Wilder, Raanana (IL); Yaniv Matza, Kfar Saba (IL)

(73) Assignee: STRAUSS WATER LTD., Petach Tikva (IL)

(21) Appl. No.: 13/978,851

(22) PCT Filed: Dec. 29, 2011
(86) PCT No.: PCT/IL2011/050085

§ 371 Date: Jul. 9, 2013

Related U.S. Application Data
(60) Provisional application No. 61/431,146, filed on Jan. 10, 2011.
(60) Provisional application No. 61/545,767, filed on Oct. 11, 2011.

(51) Int. Cl. G01F 23/26

(52) U.S. Cl. CPC G01F 23/263
USPC 73/304 C

(57) ABSTRACT

The concerns a measurement device and system utilizing the same for precise measuring the fluid level in a container, the measurement device (10) being located outside of the container (12) and comprising a predetermined number of basic blocks of a predetermined geometry, the basic blocks comprising at least one pair of capacitors with a predetermined relation between their capacitance a differential change in said relation along the device (10) being indicative the fluid level condition in the container (12).

### REFERENCE TO RELATED APPLICATIONS

This application is a national stage application under 35 USC 371 of International Application No. PCT/IL2011/050085, filed Dec. 29, 2011, which claims the priority of Provisional Application No. 61/431,146, filed Jan. 10, 2011 and Provisional Application No. 61/545,767, filed Oct. 11, 2011, the entire contents of which are incorporated herein by reference.

### FIELD OF THE INVENTION

This invention is generally in the field of fluid level measurements and relates to a measurement device and system utilizing the same for precise measuring the fluid level in a container.

### BACKGROUND OF THE INVENTION

Fluid or liquid level monitoring is critical to a wide variety of applications. In general, fluid level applications include those requiring detection of the presence or absence of fluid at a selected point, and those requiring measurement of actual fluid level (depth or height) in a container. These techniques are based on the use of fluid level sensors to indicate the level of fluid within a tank or container. Fluid level sensors utilize mechanisms of various types, including inter alia acoustic, optical, electro-optical, resistance, capacitative mechanisms. Optical, electro-optical and acoustic type sensors are too expensive for some applications.

The most commonly used fluid level sensors are the variable resistor sensor (utilizing a float to produce a resistance change in the variable resistor) and capacitive liquid level sensor (including a reference capacitor adapted to be fully submerged in the liquid and a measuring capacitor). These sensors however are too sensitive to environmental changes.

### GENERAL DESCRIPTION

The present invention provides a novel technique enabling precise measurement of a fluid level in a container using relatively simple and inexpensive equipment that can be easily used with various types of containers and environmental conditions.

The invention is based on the general principles of capacitive sensors, namely a change in capacitance caused by a change in the medium in the vicinity of the capacitor plates. A change in the level of the fluid changes the medium in the capacitor's vicinity, and hence, causes a change in capacitance.

However, contrary to the conventional approach for capacitive sensors, rather than measuring direct changes in capacitance, two or more functional capacitors are used, where each of which is differently affected by a change in the fluid level, and the fluid level is then determined by determining the differential change in capacitance between the two or more capacitors.

A measurement device of the present invention thus includes a novel capacitance-based fluid level sensor of the invention, which has a predetermined number of basic blocks (one or more basic blocks) each defining at least one pair of capacitors with a predetermined relation of capacitance between them. Such a relation may be a predetermined profile of ratio between the capacitance along said basic block (i.e. a profile of differential change). In this case, the use of one basic block might be sufficient. Alternatively, or additionally, such a relation may be a difference (change) in the capacitance between the adjacent blocks, in which case at least two basic blocks are preferably used.

If such a capacitance-based sensor of the invention is put in operation, i.e. is exposed to a fluid medium, e.g. is located in the vicinity of a fluid containing environment, the only factor affecting a change in said relation is a change in the fluid level in the vicinity of the basic block.

A fluid level measurement system of the invention includes the measurement device and a control unit. The latter is actually an electronic circuit (chip) having, inter alia, a memory utility for storing certain reference data (calibration data), and processor utility which is preprogrammed for analyzing measured data from the measurement device (using the calibration data) and providing output data indicative of the fluid condition in the container.

Generally, the fluid condition to be determined may be just presence or absence of the fluid in the vicinity of the specific basic block of the measurement device. Preferably, however, the measurement device is configured to determine the fluid condition indicative of the actual fluid level in the container.

The measurement device of the present invention is configured for attaching or placing close to the outer surface of a container, and an electrical output of the device is connectable to the control unit via wires or wireless signal transmission (IR, RF, acoustic, etc.) as the case may be. The measurement device may actually be implemented as a label, flexible or rigid, to be adhered/attached to the outer surface of the container's wall. Preferably, the measurement device and the control unit are implemented as an integral structure.

The capacitance-based sensor, and preferably the entire measurement device of the present invention, includes or is configured as an elongated ruler-like structure having a longitudinal axis, such that when the sensor is placed on the container's wall its longitudinal axis extends along an axis of a general change of the fluid level in the container. The ruler structure carries an electrodes' arrangement extending along said axis and being formed by at least one electrode cell and an additional electrode. The electrodes of the electrode cell together with the additional electrode define at least one pair of capacitors forming the basic block of the measurement device.

Preferably, an array of basic blocks is provided being arranged along said axis. Generally speaking, scaling a position along the measurement device (elongated structure) may be implemented by providing an array of basic blocks. The configuration is such that a relation between the electrode cell (capacitive cell) and the additional electrode (or a respective segment of the additional electrode common for all the cells, as will be described further below) is equal for all the basic blocks. More specifically, the basic blocks have identical configurations, e.g. have identical electrode pairs equally distanced from the additional electrode.

In the description below, the at least one pair of electrodes is at times referred to as “capacitive cell”. It should, however, be understood that a capacitor is actually formed by one of the electrodes of such cell and the corresponding additional electrode or a corresponding segment/portion of the additional electrode, as will be clear from the description below.

In some embodiments, the additional electrode extends along the capacitive cell, e.g. defining two portions extending at opposite sides of the cell. In case of an array of capacitive cells, the additional electrode is common for all the cells. This additional electrode may be configured as a closed-loop frame surrounding the array of capacitive cells or as a two-strip element enclosing the array of cells between the two strips. Thus, scaling a position along the measurement device is implemented by providing an array of cells and/or segmenting the additional electrode.

In some other embodiments, the basic block includes a capacitive cell and its own additional electrode. Thus, in case of an array of basic blocks, they are arranged along the direction of change in the fluid level in the container, and a change in said predetermined relation within the cell is indicative of a change in the fluid condition at the location of said cell, while a difference in the relation values for adjacent cells is indicative of the actual fluid level.

Thus, generally, according to the invention, each basic block comprises at least one pair of first and second capacitors, formed by first and second electrodes/plates and a common additional electrode.

As indicated above, the additional electrode may also be common for all the blocks. In this case, the first and second plates of the basic block form respectively first and second capacitors with first and second segments of said additional electrode with which the plates are aligned. Moreover, the first and second electrode plates of the cell have different geometries, such that a surface area of the first plate increases while a surface area of the second plate decreases in a direction along said axis of the ruler. For example, the first and second plates of the cell may be two triangle-like or trapezoid-like parts of a rectangle at opposite sides of the rectangle's diagonal. A ratio between the surface areas of the first and second plates of the cell varies according to a certain known profile. With such asymmetric geometry of the first and second plates of the cell, for a given plane across the cell (constituting a fluid level in a container), a first area of overlap between the first plate and the corresponding segment of the additional electrode and a second area of overlap between the second plate and its corresponding segment of the additional electrode are different. When moving said plane through the cell (i.e. corresponding to a change in the liquid level) in a direction along the axis of the ruler, the first and second areas respectively change positively and negatively or vice versa, thus creating a profile of a ratio between the capacitance values varying along said axis due to the different geometries of the first and second plates of the cell. A reference profile (i.e. when the ruler is screened from fluid medium in the container) describing a change in the ratio between the first and second areas during such movement along the cell is known. Considering the use of an array of identical basic blocks, the reference profile repeats from block to block, and all the blocks are exposed to the same environmental conditions outside the container.

As also indicated above, each of the identical basic blocks may have its own additional electrode which is a common electrode for the first and second capacitors. The first and second capacitors have different capacitance values of a known difference between them when the respective basic block is screened/shielded from the environment. This difference is common for all the basic blocks. Thus, when an array of such basic blocks is aligned along the direction of change of the fluid level, a difference between the “capacitance-difference” for the adjacent basic blocks corresponds to the fluid level in the container.

When the measurement device is put in operation, i.e. is placed on the container's wall, the only factor that can affect a change in the predetermined relation of capacitance within the basic block or between the basic blocks of the array is that associated with a change in the fluid level in the container, namely a dielectric constant of a medium between the plates of a capacitor changes. Thus, the technique of the present invention advantageously allows for eliminating a need for determination of the fluid level from actual measurement of a capacitance value (which by itself is sensitive to changes in environmental conditions other than a change in the fluid level), bur rather allows for utilizing a change in the relation (e.g. ratio profile or difference) between the capacitance values for the first and second capacitors of the basic block and/or those of the adjacent blocks, while said relation is sensitive only to the change in the liquid level.

According to one broad aspect of the invention, there is provided a measurement device for measuring a fluid level in a vicinity of the device, the measurement device comprising a capacitance-based fluid level sensor with a predetermined number of basic blocks of a predetermined geometry, the basic block comprising at least one pair of capacitors with a predetermined relation between their capacitance, a differential change in said relation along the device being indicative of the fluid level condition in the vicinity of the device.

According to another broad aspect of the invention, there is provided a measurement device for measuring a fluid level in a vicinity of the device, the measurement device comprising an elongated structure having a longitudinal axis which when said structure is put in operation extends along a general direction of change of the fluid level, the measurement device comprising: an electrodes' arrangement formed by a predetermined number of basic blocks of a predetermined geometry, the basic block comprising at least one electrode cell and an additional electrode, the electrode cell comprising first and second electrodes having different geometries such that a surface area of one of the first and second electrodes increases in a direction along said longitudinal axis while a surface area of the other of said first and second electrodes decreases in said direction, forming a certain profile of a ratio between said first and second surface areas, the first and second electrodes of the cell forming first and second capacitors with said additional electrode, a position of change in a ratio between capacitance values of the first and second capacitance along said axis being indicative of the fluid level.

According to another broad aspect of the invention, there is provided a measurement device for measuring a fluid level in a vicinity of the device, the measurement device comprising an elongated structure having a longitudinal axis which when said structure is put in operation extends along a general direction of change of the fluid level, the measurement device comprising: an electrodes' arrangement formed by at least two basic blocks of a predetermined identical geometry, the basic block comprising at least one pair of capacitors formed by first and second electrodes and an additional common electrode, the first and second capacitors having different capacitance values with a predetermined known difference between them, a position of change in said predetermined difference along said axis being indicative of the fluid level.

The measurement device is configured and operable for providing measured data indicative of a change in the relation between the capacitance within the block and/or between the blocks in a direction along said axis, said change in the relation being indicative of a change in the fluid level in the container.

Preferably, the measurement device comprises an array of said basic blocks arranged in a spaced-apart relationship along said longitudinal axis. In some embodiments utilizing a common additional electrode for multiple blocks, the first and second portions of the additional electrode extend along the opposite sides of the array.

According to yet another broad aspect of the invention, there is provided a measurement system comprising the above-described measurement device and a control unit comprising an electronic circuit configured and operable for analyzing said measured data and generating output data indicative of the fluid level in the container.

Preferably the measurement system is an integral substantially flat structure carrying the measurement device (electrodes printed on a substrate) and a chip-like control unit.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a fluid container equipped with a measurement system of the invention;

FIG. 2 illustrates a specific but not limiting example of the configuration of the measurement unit of the invention suitable for use in the system of FIG. 1, configured for capacitance ratio profile measurement;

FIG. 3 shows more specifically an example of the basic block for capacitance ratio profile measurement according to the invention for use in measurement unit.

FIGS. 4A-4B show another not limiting example of the configuration of the measurement unit (FIG. 4A) of the invention adapted for difference measurement and the configuration of the correlating basic block (FIG. 4B); and

FIG. 5 shows an electrical diagram of the measurement unit of the invention for the difference measurement configuration.

### DETAILED DESCRIPTION OF EMBODIMENTS

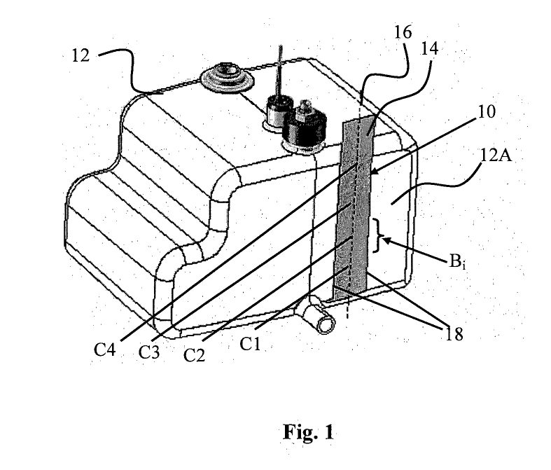

Referring to FIG. 1, there is illustrated an example of a measurement system 10 of the invention for measuring a liquid level in a container 12. The measurement system 10 is configured as a flat elongated structure (e.g. label) attachable to an outer surface of the container's wall 12A. The flat structure 10 carries a measurement device 14 and a control unit (electronic circuit) which is not shown here.

The measurement device 14 extends along the structure 10 defining a longitudinal axis 16. When the structure 10 is attached to the container's wall 12A, the axis 16 is substantially parallel to a general direction of change in the liquid level in the container 12. The measurement device 14 is configured as a capacitance-based fluid level sensor and includes a predetermined number of basic blocks, e.g. at least one basic block, or preferably, as exemplified in the figure, includes an array of a certain number of blocks, generally designated Bᵢ, four such blocks being shown in the present example. Each basic block is formed by an electrode cell C and an additional electrode 18, which as shown in the present example is common for all the basic blocks/cells and is thus a segmented electrode.

Thus, in the present example, four electrode cells C₁-C₄ are shown associated with one common electrode 18. The cells are arranged in a spaced-apart relationship along the axis 16. This arrangement, with one or more cells/basic blocks, actually presents a ruler extending along the axis of change of the liquid level in the container. The common segmented electrode 18 may be in the form of a frame surrounding the cells' array or in the form of two-strip element enclosing the array of cells between the two parallel strips extending along the axis 16.

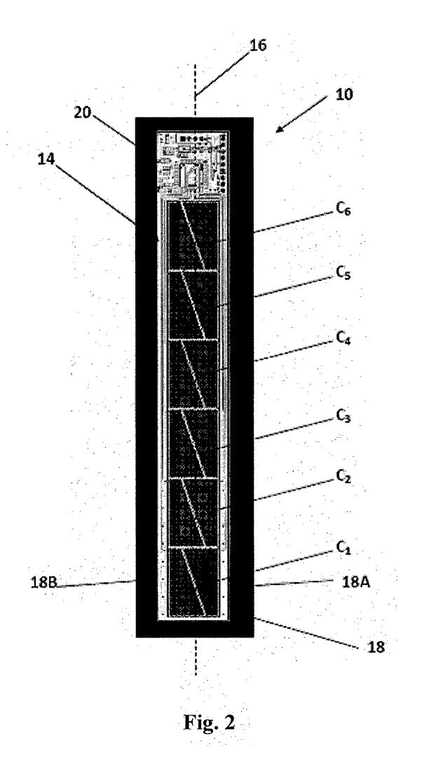

Reference is made to FIG. 2 showing more specifically an example of the measurement system 10 of the present invention for ratio profile capacitance measurement. To facilitate understanding, the same reference numerals are used for identifying common components in all the figures. The system 10 is an integral flat structure carrying the measurement device 14 and an electronic circuit 20. In the present example, the measurement device 14 includes an array of six basic blocks comprising electrode cells C₁-C₆ respectively and a common electrode 18 defining two electrode parts 18A and 18B at opposite sides of the cells' array. The cells C₁-C₆ have identical configurations and are equally distanced from the common electrode 18. Thus, a relation between the electrode 18 and the cell C is equal for all the blocks. As shown, each cell is aligned with corresponding first and second segments of the first and second electrodes 18A and 18B at opposite sides of the cell. Hence, each block includes first and second capacitors formed by the first and second electrodes of the cell and the corresponding first and second segments of the electrodes 18A and 18B.

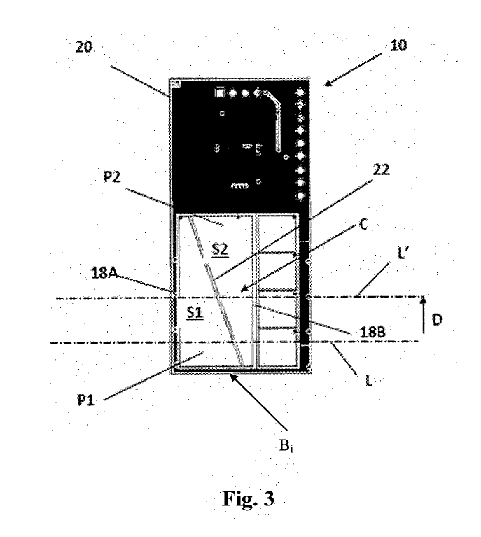

FIG. 3 illustrates more specifically the configuration of a basic block Bᵢ configured for ratio profile capacitance measurement. The block includes an electrode cell C comprising first and second electrically conductive plates P₁ and P₂ which have different geometries, designed such that a surface area S₁ of the first plate P₁ increases while a surface area S₂ of the second plate P₂ decreases in a direction D along the axis 16 of the ruler, or vice versa. As shown in this example, the first and second plates P₁ and P₂ are two triangle-like elements of a rectangle-like cell C at opposite sides of the rectangle's diagonal 22.

This asymmetric arrangement of the first and second plates P₁ and P₂ of the cell provides that for a certain plane L across the cell, a first area of overlap between the first plate P₁ and a corresponding segment of the electrode 18A and a second area of overlap between the second plate P₂ and the corresponding segment of the electrode 18B are different. Accordingly, capacitance values for the first and second capacitors formed by respectively the plate P₁ and electrode 18A and the plate P₂ and electrode 18B are different. As a result, a ratio between the corresponding first and second capacitance values changes according to a certain profile. A reference profile, corresponding to the steady state of the ruler (screened from fluid medium in the container), i.e. corresponding to a profile of the ratio between the surface areas of the plates P₁ and P₂, is known. As the blocks are identical and a relation between the common electrode 18 is the same for all the blocks, the reference profile is also the same for all the blocks. The reference profile within the block repeats from block to block.

When a liquid level in the container moves from position L to L′ through the block in a direction D, the ratio between the first and second areas changes according to the known profile. Thus, the factor that affects a change in a ratio between the first and second capacitance values for one position of the plane L (liquid level) and the first and second capacitance values for another position of the plane L′ is associated with a change in the liquid level in the container, i.e. a change in the dielectric constant of the medium between the capacitor elements. Hence, a position corresponding to a detected change in the ratio corresponds to the liquid level in the container.

The reference profile is stored in a memory utility of the electronic circuit 20, together with data corresponding to the arrangement of the cells and segmented electrode. The measurement device continuously or periodically measures voltages on all the electrodes and generates measured data indicative thereof. This data is received and analyzed by a processor utility of the electronic circuit 20 and the liquid level is calculated. The calculation may be as follows:

$$LeftCap = LeftCapVal - LeftAmbientCap$$

$$RightCap = RightCapVal - RightAmbientCap$$

$$LeftLevel = 1 - \frac{LeftCap}{LeftCap + RightCap}$$

$$RightLevel = \frac{RightCap}{LeftCap + RightCap}$$

$$Level [ \% ] = ( RightLevel + LeftLevel ) \cdot 100$$

Here, LeftCap is the measured capacitance of the first capacitor formed by the plate P₁ and corresponding segment of electrode 18A, LeftCapVal is the actual value of the corresponding capacitance, LeftAnbientCap is the effect of environment. Similarly, RightCap is the measured capacitance of the second capacitor formed by the plate P₂ and corresponding segment of electrode 18B, RightCapVal is the actual value of the corresponding capacitance, RightAnbientCap is the effect of environment.

As indicated above, the measurement device may be in the form of a flat structure such as a label, flexible or not. The electrical circuit formed by one or more basic blocks, each including at least one electrode cell C and an additional electrode 18 (e.g. common for all the cells or not), may be printed on the label. Thus, the system is simple and can be easily used with any container, irrespective of the environment where the container might be used.

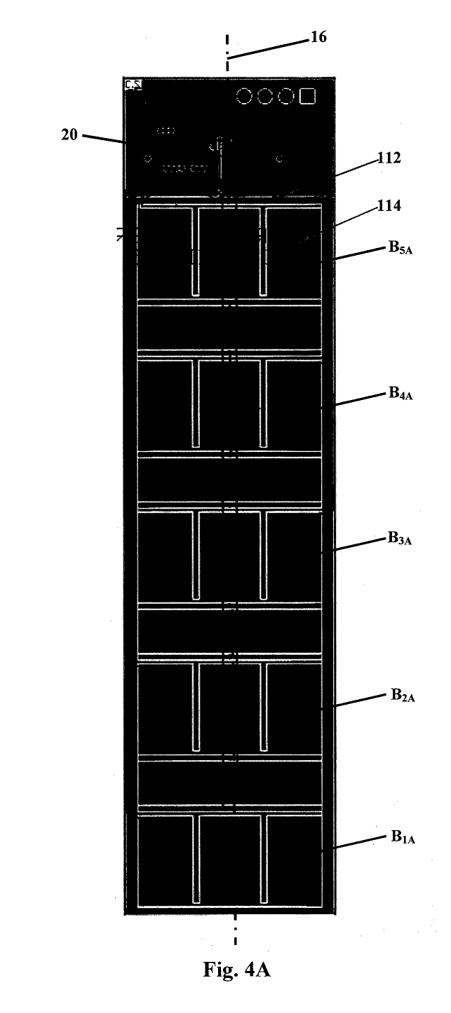

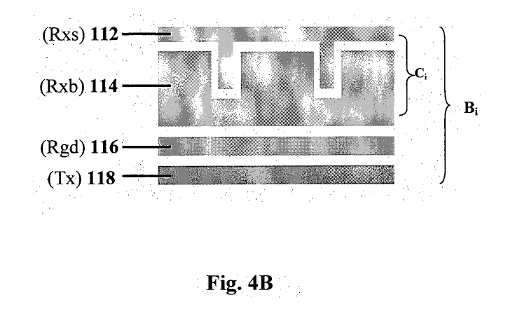

Turning now to FIGS. 4A-4B, another specific but non-limiting example of the measurement system 10 of the present invention for differential capacitance measurement is shown. In this example, the measurement device 14, being a capacitance based sensor, includes an array of multiple (generally at least two) basic blocks—five basic blocks B_{1A}-B_{5A} being shown in the figure, each comprising a relatively small electrode 112 (designated Rxs), a relatively large electrode 114 (designated Rxb), a grounding electrode 116 (designated Grd) and an additional electrode or so-called transmission electrode 118 (designated Tx. The smaller electrode and the large electrode of the block form an electrode cell, where each of the electrodes 112 and 114 defines a capacitor cell with the electrode 118. The blocks B_{1A}-B_{5A} have identical configurations and are equally distanced from each other, providing a predetermined equal incremental indication of the fluid level within the container corresponding to a difference (relation) in the capacitance between the two adjacent blocks.

FIG. 4B illustrates more specifically the configuration of the basic block Bᵢ for differential capacitance measurement. The block Bᵢ includes a capacitive cell C formed by large and small measurement electrodes, designed such that a surface area of electrode 114 is significantly larger than that of electrode 112. The difference in capacitance (C_{Rx}) is calculated between the capacitors 112-118 and 114-118 according to the following formula:

C_{Rx}=C_{Rxb}−C_{Rxs}

The values of C_{Rxb} and C_{Rxs} are measured vs. the transmission electrode 118, and then subtracted from each other to receive a capacitance differential value. As the capacitance changes significantly with the environmental conditions, such as temperature changes, while both capacitors of the block are exposed to the same environment, measurement of the differential capacitance enables eliminating the changes in the capacitance due to environmental conditions.

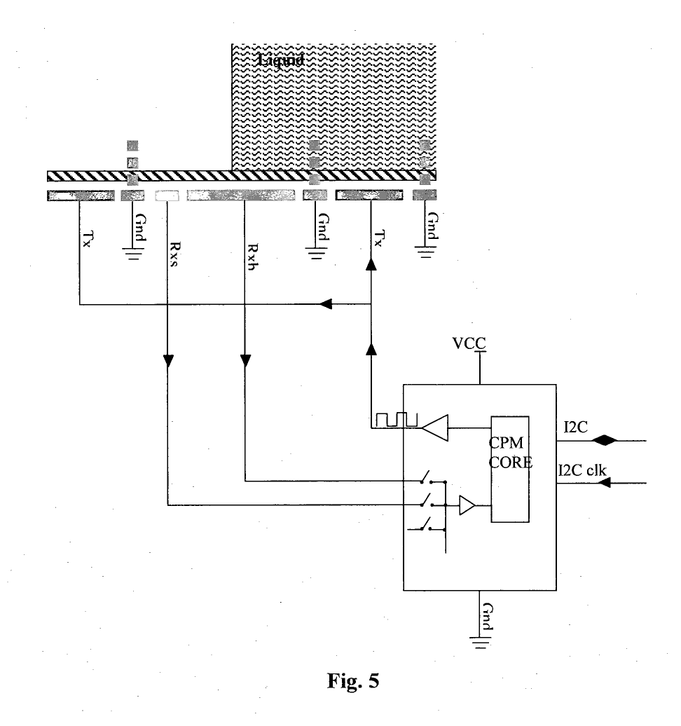

FIG. 5 is an example of a schematic electronic diagram of the block suitable to be used in the above-described measurement device. As explained above, the small electrode 112 and the large electrode 114 of the basic block, as well as the common transmission electrode, are connected to a CPM core (control unit), that translates the measured differential capacitance into incremental values, for instance 20%, 40%, 60% etc., indicating the level of the fluid in the container. The CPM core may transmit, e.g. digitally, the calculated incremental value of the fluid level to a display unit (not shown) of the device or an external unit, enabling indication of the fluid level in the container to a user. Alternatively or additionally, the value is transmitted to a control console of the device (not shown), in which filling or drainage of fluid in the container is initiated according to the level of fluid measured by the measurement device.

1. A measurement device for measuring a fluid level in a vicinity of the device, the measurement device comprising a capacitance-based fluid level sensor with a predetermined number of basic blocks of a predetermined geometry, the basic block comprising at least one pair of capacitors with a predetermined relation between their capacitance, a differential change in the relation along the device being therefore indicative of the fluid level condition in the vicinity of the device, the capacitance-based fluid level sensor comprises an elongated structure having a longitudinal axis and carrying an electrodes' arrangement defining the at least one pair of capacitors.

2. (canceled)

3. A measurement device according to claim 1, wherein electrodes' arrangement is formed by at least one electrode cell and an additional electrode defining together said at least one pair of capacitors of the basic block.

4. A measurement device according to claim 1, wherein a relation between the electrode cell and the additional electrode forming the basic block is common for all the basic blocks.

5. A measurement device according to claim 1, wherein the electrodes' arrangement defines at least one basic block.

6. A measurement device according to claim 4, wherein the electrode cell comprises first and second electrodes having different geometries such that a surface area of one of the first and second electrodes increases in a direction along the longitudinal axis while a surface area of the other of the first and second electrodes decreases in said direction, forming a profile of a ratio between the first and second surface areas, each of the first and second electrodes of the cell forming with the additional electrode first and second capacitors of the at least one pair, a position of change in the ratio between capacitance values of the first and second capacitors along the axis being indicative of a change in the fluid level.

7. A measurement device of claim 5, wherein the additional electrode comprises first and second electrode portions at opposite sides of the at least one cell, the first and second capacitors being formed by respectively the first electrode of the cell and the first portion of the additional electrode and the second electrode of the cell and the second portion of the additional electrode.

8. A measurement device according to claim 6, wherein each of the basic blocks is associated with respective first and second segments of the first and second portions of the additional electrode.

9. A measurement device according to claim 1, comprising an array of two or more of the basic blocks arranged in a spaced-apart relationship along the longitudinal axis.

10. A measurement device according to claim 1, wherein the electrodes' arrangement defines at least two basic blocks.

11. A measurement device according to claim 9, wherein the electrode cell comprises first and second electrodes having different surface areas thereby providing different capacitance for the capacitors of the at least one pair of the capacitors of the basic block of the predetermined relation, a position of change in a difference between the capacitance for adjacent basic blocks along the axis being indicative of a change in the fluid level.

12. A measurement device according to claim 1, configured and operable for providing measured data indicative of the relation in the capacitance values in a direction along the longitudinal axis, thereby enabling determination of the position of the change in the ratio and determination of the fluid level in the container.

13. A measurement device according to claim 1, wherein the elongated structure comprises a substantially flat substrate, the electrodes' arrangement being a pattern printed on a surface of the substrate, the longitudinal axis of the elongated structure extends along a general direction of change of the fluid level in the fluid container.

14. (canceled)

15. A measurement system comprising the measurement device of claim 1, and a control unit comprising an electronic circuit configured and operable for analyzing said measured data and generating output data indicative of the fluid level in the container.

16. A measurement system according to claim 13, comprising an integral ruler-like structure which is configured to be attached to a surface of a fluid container and which carries the measurement device and the control unit.

17. A capacitance-based fluid level sensor comprising an elongated structure having a longitudinal axis and carrying an electrodes' arrangement defining a predetermined number of basic blocks of a predetermined geometry, each basic block comprising at least one pair of capacitors with a predetermined relation between their capacitance, said relation being common for all the basic blocks, a differential change in said relation along the sensor when exposed to fluid environment being therefore indicative of a fluid level condition in the vicinity of the sensor.
